(19) United States
(12) Patent Application Publication
(10) Pub. No.: US 2004/0177049 A1
(43) Pub. Date: Sep. 9, 2004

(54) Method and system for protection against parallel printing of an indicium message in a closed system meter

(75) Inventors: G. Thomas Athens, Derby, CT (US); Robert A. Cordery, Danbury, CT (US); John A. Hurd, Lake Mary, FL (US); Maria P. Parkos, Southbury, CT (US); Roger J. Ratzenberger JR., Milford, CT (US)

Correspondence Address: Pitney Bowes Inc., Intellectual Property & Technology Law Department, 35 Waterview Drive, P.O. Box 3000, Shelton, CT, 06484, US

(73) Assignee: Pitney Bowes Incorporated, Stamford, CT

(21) Appl. No.: 10/378,776

(22) Filed: Mar. 4, 2003

(51) Int. Cl. G06F 17/00; G07B 17/02

(52) U.S. Cl. 705/408; 705/401

(57) ABSTRACT

A method and system that protects against a parallel printing attack is provided. During initialization of a printer and a meter, the printer provides the meter with an identification number. The identification number can be a serial number or the like, or a random number generated by the printer. The meter includes the identification number in each indicium message sent to the printer and optionally signs the message. When the printer receives an indicium message, it will compare the identification number in the indicium message to its own identification number. If the identification number is identical, the printer will print the indicium. If the identification number is not identical or the signature does not verify, the printer will not print the indicium. Thus, only the printer connected to the meter during initialization of the system will be able to print indicia generated during that session.

### FIELD OF THE INVENTION

The invention disclosed herein relates generally to value dispensing systems, and more particularly to a method and system for protecting against parallel printing of an indicium message in a closed postage metering system.

### BACKGROUND OF THE INVENTION

One example of a value printing system is a postage evidencing system including an electronic postage meter and a printer for printing a postal indicia on an envelope or other mail piece. Electronic postage meters for dispensing postage and accounting for the amount of postage used are well known in the art. The meter supplies evidence of the postage dispensed by printing indicia which indicates the value of the postage on an envelope or the like. The typical postage meter stores accounting information concerning its usage in a variety of registers. An ascending register tracks the total amount of postage dispensed by the meter over its lifetime by being incremented in the amount of the postage dispensed after each transaction. A descending register tracks the amount of postage available for use. Thus, the descending register is decremented by the amount of postage dispensed after each transaction. When the descending register has been decremented to some value insufficient for dispensing postage, the postage meter inhibits further printing of indicia until the descending register is refilled with funds.

In a closed postage metering system, the system functionality is solely dedicated to metering activity. As defined by the United States Postal Service (USPS), a closed system is a system whose basic components are dedicated to the production of information-based indicia and related functions, similar to an existing, traditional postage meter. A closed system, which may be a proprietary device used alone or in conjunction with other closely related, specialized equipment, includes the indicia print mechanism. Thus, the postage meter and the printer have traditionally been located within a single secure housing. In this environment, the communications between the postage meter and the printer are typically physically secure. However, efforts have been undertaken to provide a closed postage metering system in which the postage meter is removable from a base that houses the printer. Thus, the meter and printer are physically separable from each other and are no longer contained within the same secure housing, making the physical communication lines between the postage meter and the printer generally non-secure.

There are problems, however, with mailing machines in which the meter is physically separable from the printer. For example, since the communication link between the meter and printer is not physically secure, the communication link is vulnerable to attack by unscrupulous people attempting to defraud the postal authority of funds. For example, one type of attack is referred to as a parallel printing attack. In a parallel printing attack, multiple printers are coupled to the meter simultaneously. The connection of multiple printers can be performed by splicing into or otherwise altering the communication link or associated connectors. When the meter generates indicium data and outputs an indicium message, each printer connected to the meter will print a copy of the indicium on a different mail piece.

For example, if there are n printers coupled to the meter, the same indicium will be printed on n mail pieces, while postage is only accounted for once. The postal authority will therefore be defrauded of an amount of funds equal to (n−1) multiplied by the postage value of the indicium for each indicium generated utilizing such a parallel printing attack.

It would be desirous to be able to protect against such parallel printing attacks, thereby providing security to prevent the stealing of funds and/or services from the postal authority. Thus, there exists a need for a method and system that protects against a parallel printing attack in a closed system postage meter.

### SUMMARY OF THE INVENTION

The present invention alleviates the problems associated with the prior art and provides a method and system that protects against a parallel printing attack in a closed system postage meter.

In accordance with the present invention, during initialization of the printer and the meter, the printer provides the meter with an identification number. The identification number can be a serial number or the like, or a random number generated by the printer. The meter includes the identification number in each indicium message sent to the printer. Optionally, the indicium message can be digitally signed by the meter. When the printer receives an indicium message, if it is signed, the printer will verify the signature and compare the identification number in the indicium message to its own identification number. If the identification number is identical, the printer will print the indicium. If the identification number is not identical or the signature is not verified, the printer will not print the indicium. Thus, according to the present invention, only the printer connected to the meter during initialization of the system will be able to print indicia generated during that session.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 illustrates in block diagram form a mailing machine that protects against a parallel printing attack in accordance with the present invention;

FIG. 2 illustrates in flow chart form the processing performed during power-up initialization of a postage meter that protects against a parallel printing attack in accordance with the present invention; and

FIGS. 3A and 3B illustrate in flow chart form the processing performed during indicia generation and printing by the postage meter that protects against a parallel printing attack in accordance with the present invention.

### DETAILED DESCRIPTION OF THE PRESENT INVENTION

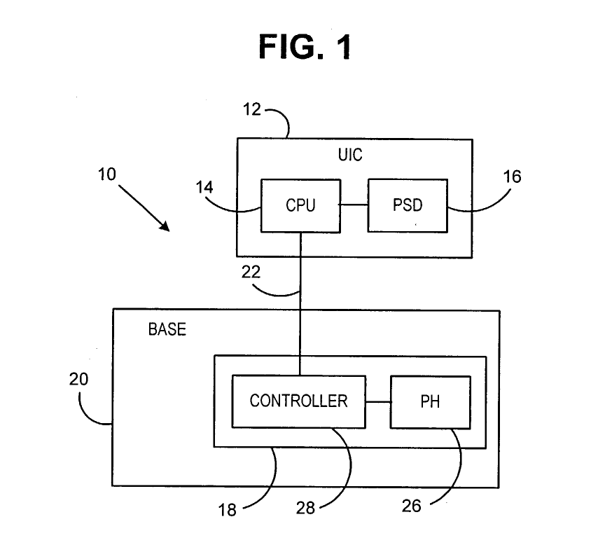

In describing the present invention, reference is made to the drawings, wherein there is seen in FIG. 1 in block diagram form a mailing machine 10 that protects against parallel printing of an indicium message in accordance with the present invention. Mailing machine 10 is a closed system postage meter in which the meter is physically separable from the printer as described below. Mailing machine 10 includes a control panel device 12, hereinafter referred to as a User Interface Controller (UIC), that performs user interface and control functions for the mailing machine 10. Specifically, the UIC 12, in conjunction with one or more processors or controllers, such as, for example, central processing unit 14, provides all user interfaces, executes control of the mailing machine 10, calculates postage for debit based upon rate tables, provides the conduit for an embedded Postal Security Device (PSD) 16 to transfer postage indicia to a printer 18, operates with peripherals for accounting, printing and weighing, and conducts communications with a remote data center (not shown) for postage funds refill, software download, rates download, and market-oriented data capture. The PSD 16 contains one or more registers that store the accounting information concerning usage, such as, for example, an ascending register, descending register, piece count register, and the like. The UIC 12, in conjunction with the embedded PSD 16, provides the system meter that satisfies U.S. and international postal regulations regarding closed system information-based indicia postage (IBIP) meters. The UIC 12 is mounted to a base 20, such as, for example, by a docking station, connector or the like, that houses the printer 18. The base 20 processes a mail piece and provides it in the proper position for printing of the postage indicia by the print head 26 of printer 18 under control of the print head controller 28. Thus, an indicium message generated by the PSD 16 is sent, via communication link 22, to the controller 28 of the printer for processing, and the controller 28 generates signals sent to the print head 26 for printing the indicium. Since the UIC 12 is removable from the base 20 that includes the printer 18, the communication link 22 is not physically secure.

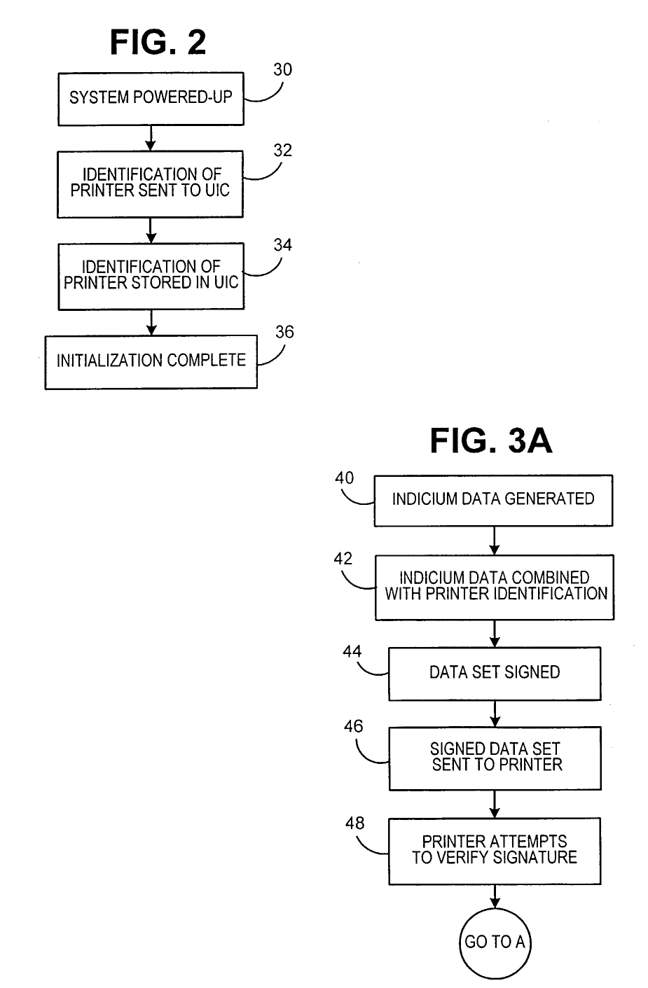

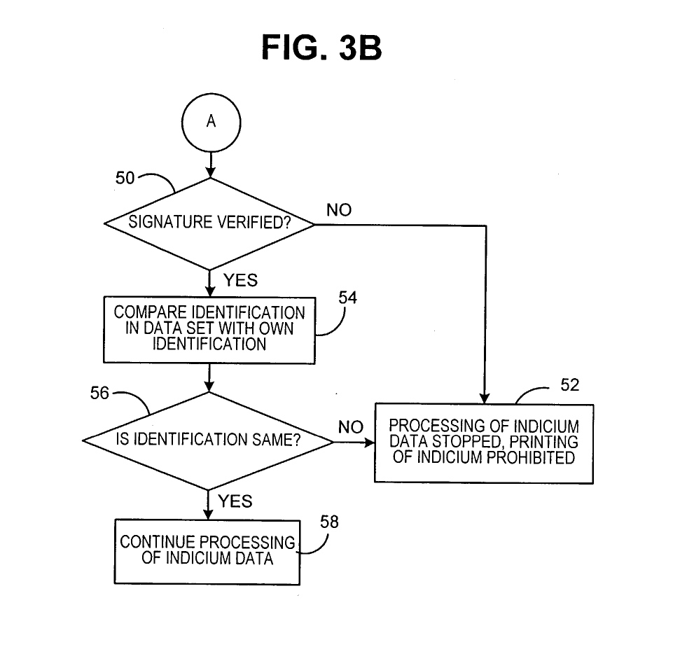

In accordance with the present invention, the mailing machine 10 protects against parallel printing of an indicium message as illustrated in FIGS. 2, 3A and 3B. Referring now to FIG. 2, there is illustrated in flow chart form the processing performed during power-up initialization of a postage meter that protects against a parallel printing attack in accordance with the present invention. The method of FIG. 2 will be described with respect to the mailing machine 10 as illustrated in FIG. 1, but it should be understood that the present invention is not so limited and can be utilized by any type of postage meter or value dispensing system susceptible to a parallel printing attack. As shown in FIG. 2, in step 30, the mailing machine 10 is powered-up and an initialization procedure will be performed. In step 32, a unique identification associated with the printer 18 (hereinafter referred to as identification or identification number) is provided to the UIC 12. The unique identification could be provided directly from the printer 18 to the UIC 12, or alternatively from another source, such as, for example, a remote data center (not shown) coupled to the mailing machine 10. The unique identification could be, for example, a unique serial number of the printer 18. The serial number could be, for example, stored in a non-volatile memory (not shown) in the printer 18. Preferably, the non-volatile memory is secure such that the printer serial number is unable to be determined or altered within the printer 18. Alternatively, the unique identification could be a random number, alpha-numeric sequence, or any other type of unique identifying data that is generated each time the mailing machine 10 is power cycled and stored in non-volatile memory within the printer 18. The identification could be generated, for example, by controller 28 in the printer 18, or by any type of random number generator (not shown) in printer 18 or at a data center (not shown) coupled to the mailing machine 10. Preferably, the generated identification is large enough, such as, for example, greater than four bytes, such that it is statistically improbable that the same identification for two printers would be generated at the same time. As noted above, if an identification is being generated (as opposed to using a unique serial number), a new identification associated with the printer 18 will be generated each time the mailing machine 10 is cycled through a power-up procedure.

In step 34, the identification number associated with the printer 18 is stored by the UIC 12. Preferably, the identification number is stored in the PSD 16, thereby protecting the security of the identification number associated with the printer 18. Alternatively, the identification number may be stored in a memory (not shown) in the UIC 16. Of course, to protect the security of the identification number, the memory must be secure to prevent any tampering with the identification number. The identification number associated with the printer 18 will be included in each indicium data provided by the PSD 16 to the printer 18 to prevent parallel printing of the indicium data as further described below. Optionally, the identification number may be cryptographically protected, such as, for example, by a digital signature generated by the printer 18, before being sent to the UIC 12. The digital signature could be generated, for example, by the controller 28 of printer 18. In this manner, any modification of the identification number before it reaches the UIC 12 can be detected upon verification of the signature by the UIC 12. The printer 18 can store a private cryptographic key that can be utilized in the generation of the digital signature. The corresponding public key, utilized to verify the signature generated using the private key, can be obtained in a traceable, verifiable manner to ensure the integrity of the key pair. This can be achieved using any type of well known key management methods, including, for example, standard Public Key Infrastructure (PKI) methods. Preferably, a key exchange between the printer 18 and PSD 16 occurs during initialization of the printer 18 and PSD 16.

In step 36, the initialization of the mailing machine 10 is completed and the mailing machine 10 is ready to process mail pieces. It should be understood that the initialization procedure defines a current operating, session between the printer 18 and the UIC 12. Thus, each time an initialization procedure is performed, i.e., each time the mailing machine 10 is power cycled, a new session will be defined.

Referring now to FIG. 3A, there is illustrated in flow chart form the processing performed during indicia generation and printing by a postage meter that protects against a parallel printing attack in accordance with the present invention. The method of FIG. 3A will be described with respect to the mailing machine 10 as illustrated in FIG. 1, but it should be understood that the present invention is not so limited and can be utilized by any type of postage meter or value dispensing system susceptible to a replay attack.

As shown in FIG. 3A, in step 40 the PSD 16 generates the indicium data for a mail piece. The exact procedure for the generation of the indicium data and its content is not necessary for an understanding of the present invention, and therefore no further description is necessary. In step 42, the indicium data is combined with the identification number associated with the printer 18, received in step 32 of FIG. 2, to form a data set.

Preferably, the data set formed in step 42 is cryptographically protected, such as, for example, by a digital signature generated by the PSD 16. In this manner, the data set can be authenticated and verified by the printer 18, using the corresponding public key of the PSD 16. The PSD 16 stores a private cryptographic key that can be utilized in the generation of the digital signature. The corresponding public key, utilized to verify the signature generated using the private key, can be obtained in a traceable, verifiable manner to ensure the integrity of the key pair. This can be achieved using any type of well known key management methods, including, for example, standard Public Key Infrastructure (PKI) methods. As noted above, a key exchange between the printer 18 and PSD 16 preferably occurs during initialization of the printer 18 and PSD 16. If the data, set is to be signed, then in step 44, the data set formed in step 42 is digitally signed by the PSD 16 using its private key. It should be noted that some postal requirements currently require a digital signature with respect to the indicium data. The specific data that must be signed is specified by the postal authority, and may not contain the identification number of the printer 18. In this situation, the data set would be oversigned with a second digital signature. Thus, the indicium data, required by the postal regulations to be signed, would be signed with a first signature, and the data set, i.e., the signed indicium data and the identification of the printer 18, would be signed again. Preferably, the second signature utilizes the same private key for signing as the first signature. In step 46, the data set, or if signed in step 44, the signed data set, is sent to the printer 18 via the UIC 12.

In step 48, when the printer 18 has received the signed data set, the printer 18 will attempt to verify the signature of the data set using the corresponding public key of the PSD 16. Verification could be performed, for example, by the controller 28 of printer 18. Verification of the signature provides assurance that the incoming data set has not been tampered with or altered and that it is originating from the PSD 16 that was connected when the mailing machine 10 was powered-up. Thus, for example, if the data set has been altered in any manner the signature will not be verified. Additionally, if the data set was generated by a PSD other than the PSD 16 coupled to the printer 18 at power-up, the signature will also not be verified, as the private/public key pair will be different, and the printer 18 will not have the appropriate public key. Referring now to FIG. 3B, the processing from FIG. 3A continues in step 50, where it is determined by the printer 18 if the signature of the data set is verified. If in step 50 it is determined that the signature is not verified, then in step 52, further processing of the indicium data will not occur, printing of the indicium data will be prohibited and the printer 18 will not print the indicium data. Optionally, if desired, in step 52 the printer 18 could send a signal to the UIC 12 indicating the processing has stopped and the indicium data will not be printed. UIC 12 could then display a message to the operator indicating the operating status. If the data set is not signed, then it should be understood that the processing as illustrated in steps 44, 48 and 50 need not be performed.

If in step 50 it is determined that the signature is verified, then in step 54 the identification number included in the data set is compared with the identification number associated with the printer 18 for that power-up session. Thus, for example, if the identification number is a serial number of the printer 18, the printer 18 could retrieve its serial number from memory. If the identification number is a generated random number, the printer 18 can retrieve the random number from its memory. The comparison could be performed, for example, by controller 28. In step 56 it is determined, by the controller 28, for example, if the identification number in the data set is the same as the identification number stored by the printer 18.

If in step 56 it is determined that the identification number in the data set is not the same as the identification number associated with the printer 18, then in step 52 further processing of the indicium data will not occur, printing of the indicium data will be prohibited and the printer 18 will not print the indicium data. For example, the controller 28 could prevent the indicium data from being sent to the print head 26. Recall that the identification of the printer 18 was either a unique serial number, or a randomly generated number sufficiently large such that it is improbable that two printers will generate the same identification at the same time, and the identification was sent to the UIC 12 only once during the initialization procedure (system power-up). Thus, according to the present invention, only the printer coupled to the UIC 12 during the initialization procedure will have the same identification number as the identification included in the data set from the UIC 12. If multiple printers are coupled during the initialization procedure, the UIC 12 can alert the operator of such condition and indicate that only a single printer will be recognized and can be utilized for printing.

If in step 56 it is determined that the identification number in the data set is the same as the identification number associated with the printer 18, then in step 58 the processing of the indicium data will continue and the indicium data can be printed by the printer 18. Since the identification numbers are the same, this indicates that printer 18 was connected to the UIC 12 during power-up and is the printer authorized to print the indicium data generated by UIC 12. The processing of the indicium data in step 58 includes printing the indicium data.

It should be understood that the specific sequence of the above steps 50-56 need not be as described, but can be performed in any sequence desired. For example, the comparison of the identification could be performed before the signature verification. Additionally, the processing could be performed by the controller 28, or a separate processor within the printer 18.

The generation and processing of the data set as described above will be the same for every indicium data generated by the PSD 16. Thus, the identification number associated with the printer 18 needs only to be sent to the UIC 12 once during initialization between the printer 18 and UIC 12, and will be included in each data set generated subsequent to the initialization until a new initialization procedure is performed. This saves considerable processing time as compared with having to send a new, different identification number for each data set generated by the UIC 12. Thus, according to the present invention, a method and system that protects against a parallel printing attack in a closed system postage meter is provided. By including an identification of the printer 18 coupled to the UIC 12 during initialization with each indicium message generated by the UIC 12, the UIC 12 and printer 18 are linked during that session such that any indicia messages generated by the UIC 12 during that session can only be printed by the printer 18. If any indicia messages generated by the UIC 12 during that session are received by a printer other than printer 18, they will not be printed. Those skilled in the art will also recognize that various modifications can be made without departing from the spirit of the present invention. For example, the processing as illustrated in FIGS. 2, 3A and 3B can be performed utilizing software, hardware, firmware or any combination thereof. As another example, it should be understood that although the present invention was described with respect to a postage metering system, the present invention is not so limited and is applicable to any type of value metering system or controlled printing environment where it is desired to prevent print data generated by a processor from being parallel printed simultaneously by multiple printers.

While preferred embodiments of the invention have been described and illustrated above, it should be understood that they are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A mailing machine comprising:
a printer; and
a meter coupled to the printer, the meter to generate indicium data, the meter receiving an identification during initialization of a current session, the meter combining each indicium data generated during the current session with the identification to form a respective data set and sending each data set to the printer,
wherein the printer, upon receiving each data set from the meter, compares the identification in each data set to its own identification, and if the identification in a respective data set is different than its own identification, the printer will not print the indicium data in the data set.

2. The mailing machine of claim 1, wherein the identification is a serial number of the printer.

3. The mailing machine of claim 1, wherein the identification is generated by the printer.

4. The mailing machine of claim 3, wherein the identification is a random number.

5. The mailing machine of claim 3, wherein the identification is an alpha-numeric sequence.

6. The mailing machine of claim 3, wherein a new session is defined each time the mailing machine is power cycled, and a new identification is generated for each new session.

7. The mailing machine of claim 1, wherein the identification is sent from the printer to the meter.

8. The mailing machine of claim 7, wherein the printer digitally signs the identification before it is sent to the meter.

9. The mailing machine of claim 1, wherein the identification received by the meter is sent from a remote data center.

10. The mailing machine of claim 1, wherein the meter digitally signs the data set before sending the data set to the printer.

11. The mailing machine of claim 10, wherein the printer verifies the signature of the data set.

12. The mailing machine of claim 1, wherein the meter is removable from the printer.

13. A method for a printer to process print data generated by a processor comprising:
receiving, at the processor, an identification associated with the printer during initialization of the printer with the processor, the initialization defining a current session between the printer and the processor;
combining each set of print data generated during the current session with the received identification to form a respective data set;
sending each data set from the processor to the printer;
comparing, at the printer, the identification in a respective data set with the identification associated with the printer;
processing the print data in the data set if the identification in the data set is identical to the identification associated with the printer; and
discontinuing processing of the print data in the data set if the identification in the data set is different than the identification associated with the printer.

14. The method of claim 13, wherein the identification associated with the printer is a serial number of the printer.

15. The method of claim 12, wherein the identification associated with the printer is generated by the printer, and the method further comprises:
providing the generated identification from the printer to the processor.

16. The method of claim 15, wherein a new session is defined each time the processor and printer are power cycled, and a new identification is generated for each new session.

17. The method of claim 13, wherein the identification is a random number.

18. The method of claim 13, wherein the identification is an alpha-numeric sequence.

19. The method of claim 13, wherein the received identification is signed with a digital signature.

20. The method of claim 13, wherein the identification associated with the printer is received by the processor from a remote data center.

21. The method of claim 13, wherein sending each data set further comprises:
signing each data set with a digital signature; and
sending each signed data set from the processor to the printer.

22. The method of claim 21, wherein comparing further comprises:
verifying the signature of the data set,
wherein if the signature is not verified, processing of the print data will be discontinued.

23. The method of claim 13, wherein the processor includes a postage meter, and the print data is indicium data generated by the postage meter.

24. The method of claim 13, wherein processing the print data further comprises:
printing the print data.

25. A method for a printer to process indicium data generated by a meter comprising:
receiving a data set from the meter, the data set including the indicium data and a serial number of a printer coupled to the meter during initialization and provided to the meter during initialization of the printer with the meter;
comparing the serial number in the data set with the printer's own serial number;
continuing processing of the indicium data if the serial number in the data set is identical to the printer's own serial number; and
discontinuing processing of the indicium data if the serial number in the data set is different than the printer's own serial number.

26. The method of claim 25, wherein the data set received from the meter is signed with a digital signature, and the method further comprises:
verifying the signature of the data set,
wherein if the signature is not verified, processing of the indicium data will be discontinued.

27. The method of claim 25, wherein discontinuing processing of the indicium data further comprises:
prohibiting printing of the indicium data.

28. The method of claim 27, further comprising:
indicating processing of the indicium data has been discontinued.

29. The method of claim 25, further comprising:
sending the serial number of the printer from the printer to the meter during initialization of the printer with the meter.
